(19) United States
(12) Patent Application Publication
(10) Pub. No.: US 2022/0389716 A1
(43) Pub. Date: Dec. 8, 2022

(54) INTEGRATED ROOF SYSTEM WITH EMBOSSED SILICONE ROOF PLANKS

(71) Applicant: LOUISIANA-PACIFIC CORPORATION, Nashville, TN (US)

(72) Inventors: SARATH VEGA-GUTIERREZ, NASHVILLE, TN (US); JARROD KEVIN LINE, Nashville, TN (US)

(21) Appl. No.: 17/685,048

(22) Filed: Mar. 2, 2022

Related U.S. Application Data
(60) Provisional application No. 63/155,343, filed on Mar. 2, 2021.

(51) Int. Cl. E04D 3/35

(52) U.S. Cl. CPC E04D 3/351

(57) ABSTRACT

A multi-layered integrated roofing plank or panel with a base layer comprising engineered or manufactured wood, a water resistant barrier layer covering at least the outer face of the base layer, and at least one of the edges of the base layer. A silicone layer may cover at least a portion of the outer face. The silicone layer may be embossed with a pattern. A texturizing material also may be affixed to, or integrated with, the water resistant barrier layer. The edges of the roofing plank or panel may be configured as part of a joint with adjacent planks or panels, including, but not limited to, shiplap joints, tongue-and-groove joints, bead-and-cove joints, butt joints, or combinations or variations thereof.

This application claims benefit of and priority to U.S. Provisional App. No. 63/155,343, filed Mar. 2, 2021, which is incorporated herein in its entirety by specific reference for all purposes.

### FIELD OF INVENTION

This invention relates to a multi-layered engineered structural panel or plank (which can be wood-based, such as oriented-strand board/OSB, plywood, or other lignocellulosic-based panel) used for integrated roofing sheathing, with embossed silicone roof planks.

### BACKGROUND OF THE INVENTION

Current roof assemblies are typically multiple layers of several materials, each performing a single function, that are installed separately on the site in which the building is being constructed. In many roofing systems, there is a deck, an underlayment barrier on top of the deck, covered by a surface layer of shingles (e.g., asphalt, ceramic, metal, and the like). Compatibility between the various layers creates challenges not only for the designer, but also for the installers. In addition, a varied and large amount of materials are required during the installation, as well as during maintenance (e.g., re-roofing).

A central layer in most such assembles in a wood panel product, or an integral composite engineered panel product, including, but not limited to, engineered wood composite products formed of lignocellulosic strands or wafers (sometimes referred to as oriented-strand board, or OSB). Products such as fiberboard and particleboard have been found to be acceptable alternatives in most cases to natural wood paneling, sheathing and decking lumber. Fiberboard and particleboard are produced from wood particles bonded together by an adhesive, the adhesive being selected according to the intended use of and the properties desired for the lumber. Often times, the adhesive is combined with other additives to impart additional properties to the lumber. Additives can include, but are not limited to, fire retardants, insect repellants, moisture resistant substances, fungicides and fungal resistant substances, and color dyes. A significant advantage of fiberboard and particleboard lumber products is that they have many of the properties of plywood, but can be made from lower grade wood species and waste from other wood product production, and can be formed into lumber in lengths and widths independent of size of the harvested timber.

A major reason for increased presence in the marketplace of the above-described product alternatives to natural solid wood lumber is that these materials exhibit properties like those of the equivalent natural solid wood lumber, especially, the properties of retaining strength, durability, stability and finish under exposure to expected environmental and use conditions. A class of alternative products are multilayer oriented wood strand particleboards, particularly those with a layer-to-layer oriented strand pattern, such as OSB. Oriented, multilayer wood strand boards are composed of several layers of thin wood strands, which are wood particles having a length which is several times greater than their width. These strands are formed by slicing larger wood pieces so that the fiber elements in the strands are substantially parallel to the strand length. The strands in each layer are positioned relative to each other with their length in substantial parallel orientation and extending in a direction approaching a line which is parallel to one edge of the layer. The layers are positioned relative to each other with the oriented strands of adjacent layers perpendicular, forming a layer-to-layer cross-oriented strand pattern. Oriented, multilayer wood strand boards of the above-described type, and examples of processes for pressing and production thereof, are described in detail in U.S. Pat. Nos. 3,164,511, 4,364,984, 5,435,976, 5,470,631, 5,525,394, 5,718,786, and 6,461,743, all of which are incorporated herein in their entireties by specific reference for all purposes.

### SUMMARY OF INVENTION

In various exemplary embodiments, the present invention comprises a multi-layer panel for use as integrated structural sheathing on a roof with a silicone coating. The multi-layer panel comprises a wood structural panel, such as OSB or plywood. The panel may be coated or treated, during or after the manufacturing process, with a product that provides various properties, such as, but not limited to, weather resistance, fungus resistance, insect resistance, and/or fire resistance. The treatment may be integrated with the material forming the wood structural panel, or may be a coating on one or both surfaces.

A weather or water resistive barrier (WRB) of some kind is applied to the upper or outward facing surface of the panel, effectively serving as an underlayment. The outer surface of the WRB may then coated with an adhesive and/or asphalt, which is turn is coated or mixed with a granular or solid material 40 (such as, but not limited to, ceramic coated granules, clay, rock, glass, sand, slate, or combinations thereof). In some alternatives, the WRB itself may be coated or mixed with the granular or solid material. As described below, silicone may be used as the WRB layer, or as the layer or coating applied to the WRB (i.e., mixed with or coated with the granular or solid material), or both (i.e., when integrated).

The invention thus in several embodiments combines a structural sheathing panel, WRB layer, and surface shingle layer in one multi-layer panel product, which is less reliant on skilled labor for installation at a job site and reduces installation time by eliminating the application of a WRB system and a shingle layer or metal layer in the installation process. In some embodiments, the WRB may be a separate layer, or it may be integrated with the surface shingle layer.

The present invention applies the WRB (and other layers, if present) to the panel at the manufacturing facility, prior to shipping or installation at a job site (and thereby avoiding the problems noted above). In one embodiment, a fluid or liquid applied membrane is applied via one or more spray nozzles in a manufactured line process. The spray nozzle or nozzles are in fluid communication with one or more storage tanks, and the liquid may be stored without the use of agitators. As the panel travels down a secondary production line, the WRB coating is sprayed on the top face, and in some embodiments, also the edges, of the panel at a minimum thickness of 5-10 mils. If the coating is not sprayed on the edges, the edges are sealed by other means. The asphalt/adhesive, silicone, or other layers may be applied in a similar manner. In other embodiments, the WRB may be a solid layer (e.g., paper overlay) that is applied during the panel manufacturing process.

Silicone may be used as part of the integrated roofing panel or plank. Silicone is bulk water resistant, while also being air vapor or gas vapor permeable. In various configurations, silicone may be directly applied to the OSB or wood-based substrate of the panel, silicone may be applied to a paper overlay applied to the panel, or silicone may be applied to a separate WRB layer that is applied to the panel. As discussed above, the silicone may or may not be mixed with or coated with sand or other forms of granular or solid material, which may provide slip or skid resistance and/or an aesthetic texture or appearance.

The silicone coating typically has a shiny, rubber-like appearance that can be a detriment due to this unaesthetic appearance. The present invention solves this problem by embossing the silicone during manufacturing. The silicone is applied to the surface of the roofing panel or plank, and then is placed on a plastic surface with a pattern (or the plastic surface or plaque with the pattern is applied to the silicone), while the silicone is still at least semi-fluid and not fully cured. The plastic surface comprises a polymer or other material that does not bind to silicone. After the silicone has become fully crosslinked, the patterning plaque is easily separated from the roofing panel or plank, leaving the pattern or design from the plastic surface or plaque embossed in the silicone which is now part of the roofing panel or plank. The embossment may be used alone, or in combination with the introduction of sand or other forms of granular or solid material, as discussed above.

### BRIEF DESCRIPTION OF THE DRAWINGS

FIG. 1 shows a sectional view of a roofing panel in accordance with an embodiment of the present invention.

FIG. 2 shows a view of embossed silicone coating in accordance with an embodiment of the present invention.

FIG. 3 shows a section view of a roofing panel with silicone layer being embossed.

### DETAILED DESCRIPTION OF EXEMPLARY EMBODIMENTS

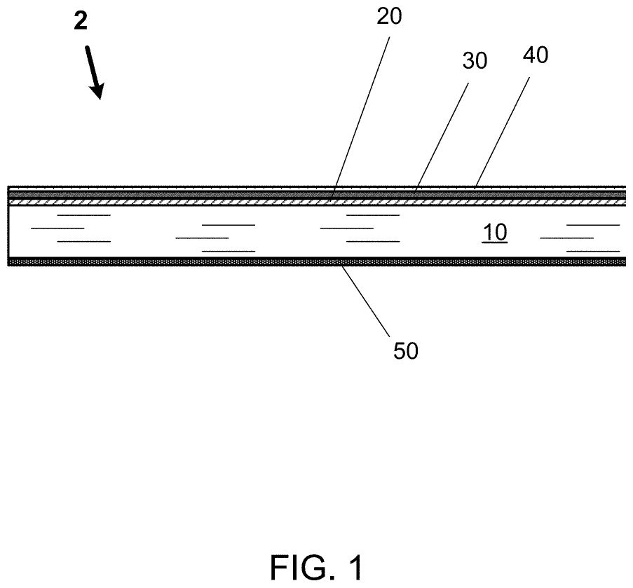

In various exemplary embodiments, as seen in FIG. 1, the present invention comprises a multi-layer panel 2 for use as integrated structural sheathing on a roof with a silicone coating 90. In the embodiment shown, the multi-layer panel comprises a wood structural panel 10, such as OSB or plywood. The panel may be coated or treated, during or after the manufacturing process, with a product that provides various properties, such as, but not limited to, weather resistance, fungus resistance, insect resistance, and/or fire resistance. The treatment may be integrated with the material forming the wood structural panel, or may be a coating on one or both surfaces. Examples of integrated roofing panels are disclosed in U.S. patent application Ser. No. 17/068,712, which is incorporated herein in its entirety by specific reference for all purposes.

In the embodiment shown, a weather or water resistive barrier (WRB) 20 of some kind is applied to the upper or outward facing surface of the panel 10, effectively serving as an underlayment. The outer surface of the WRB may then coated with an adhesive and/or asphalt 30, which is turn is coated or mixed with a granular or solid material 40 (such as, but not limited to, ceramic coated granules, clay, rock, glass, sand, slate, or combinations thereof). In some alternatives, the WRB itself may be coated or mixed with the granular or solid material. As described below, silicone may be used as the WRB layer, or as the layer applied to the WRB (i.e., mixed with or coated with the granular or solid material), or both (i.e., when integrated).

The invention thus in several embodiments combines a structural sheathing panel, WRB layer, and surface shingle layer in one multi-layer panel product, which is less reliant on skilled labor for installation at a job site and reduces installation time by eliminating the application of a WRB system and a shingle layer or metal layer in the installation process. In some embodiments, the WRB may be a separate layer, or it may be integrated with the surface shingle layer.

The present invention applies the WRB (and other layers, if present) to the panel at the manufacturing facility, prior to shipping or installation at a job site (and thereby avoiding the problems noted above). In one embodiment, a fluid or liquid applied membrane is applied via one or more spray nozzles in a manufactured line process. The spray nozzle or nozzles are in fluid communication with one or more storage tanks, and the liquid may be stored without the use of agitators. As the panel travels down a secondary production line, the WRB coating is sprayed on the top face, and in some embodiments, also the edges, of the panel at a minimum thickness of 5-10 mils. If the coating is not sprayed on the edges, the edges are sealed by other means. The asphalt/adhesive, silicone, or other layers may be applied in a similar manner. In other embodiments, the WRB may be a solid layer (e.g., paper overlay) that is applied during the panel manufacturing process.

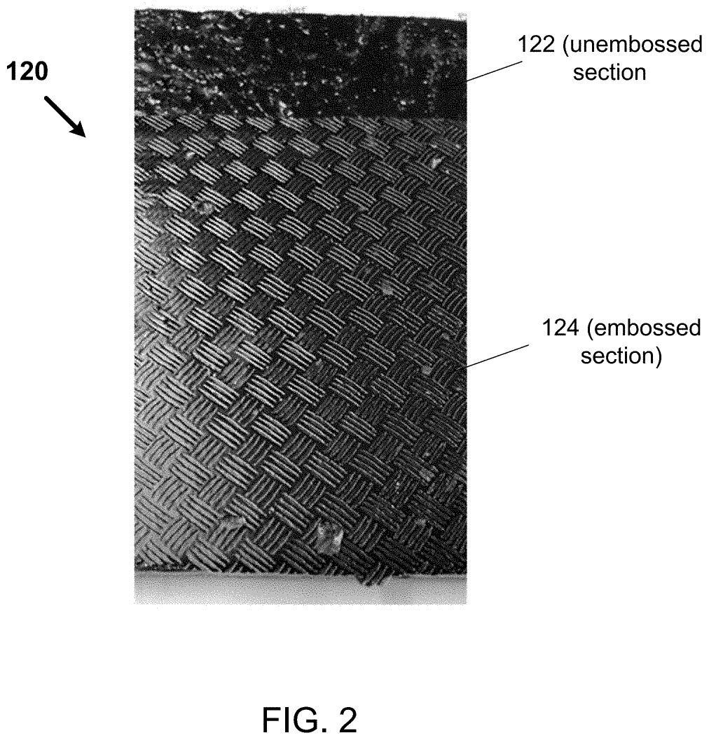

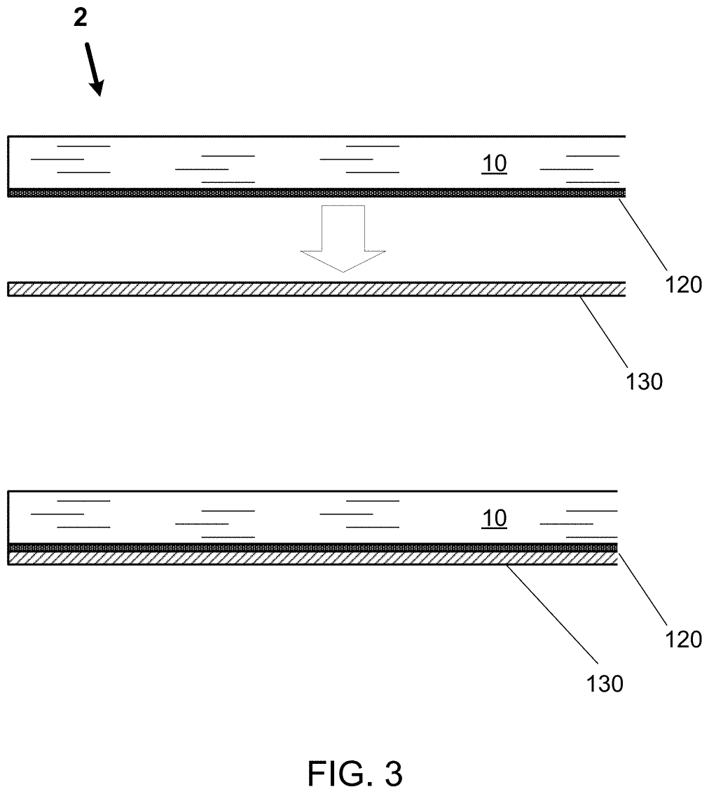

In one exemplary embodiment, as seen in FIGS. 2 and 3, silicone 120 is used as part of the integrated roofing panel or plank 2. Silicone is bulk water resistant, while also being air vapor or gas vapor permeable. In various configurations, silicone may be directly applied to the OSB or wood-based substrate of the panel, silicone may be applied to a paper overlay applied to the panel, or silicone may be applied to a separate WRB layer applied to the panel. As discussed above, the silicone may or may not be mixed with or coated with sand or other forms of granular or solid material, which may provide slip or skid resistance and/or an aesthetic texture or appearance.

The silicone coating typically has a shiny, rubber-like appearance 122 that can be a detriment due to this unaesthetic appearance. The present invention solves this problem by embossing 124 the silicone during manufacturing. The silicone 120 is applied to the surface of the roofing panel or plank, and then is placed on a plastic surface or plaque 120 with a pattern (or the plastic surface or plaque with the pattern is applied to the silicone), while the silicone is still at least semi-fluid and not fully cured. FIG. 3 shows the roofing panel or plank inverted, with the top layer with silicone on the bottom in the process of being placed on the embossing surface. The plastic surface comprises a polymer or other material that does not bind to silicone. After the silicone has become fully crosslinked, the patterning plaque 130 is easily separated from the roofing panel or plank, leaving the pattern or design 124 from the plastic surface or plaque embossed in the silicone which is now part of the roofing panel or plank. The embossment may be used alone, or in combination with the introduction of sand or other forms of granular or solid material, as discussed above. The embossed pattern is intended to provide an aesthetic appearance to the outer surface, and is not intended to provide additional traction or increase the coefficient of friction of the outer surface. In some embodiments, however, the pattern may provide additional traction or increase the coefficient of friction of the outer surface as a secondary effect.

The silicone coating may be applied in a thickness of approximately 5 to approximately 30 mils. The thickness may depend on the intended use. Panels for use with storage sheds or the like, for example, may have a silicone thickness of from approximately 10 to approximately 20 mils, or preferably approximately 14 to approximately 15 mils. For residential or light commercial use, in contrast, the panels may have a silicone thickness of from approximately 20 to approximately 25 mils.

In some embodiments, waterproof materials such as acrylics or fiberglass may be used in place of silicone.

The present invention possesses several advantages over the prior art. It provides a superior barrier system that does not allow air movement between the panel face and the applied WRB, and allows a savings in time and labor. Further, coating the panels in a controlled setting (e.g., manufacturing facility), allows the thickness of the coatings to be consistently applied, and allows the coating the opportunity to fully bond with the panel or adjacent layer. More specifically, the coatings can fully cure independent of weather conditions, and be applied without interference from construction-related dirt, debris or humidity. Further, the mineral granules or other texture-providing material may be included to increase the aesthetic appeal of the product, as well as to serve as a cooling agent in some cases, thereby enhancing energy efficiency.

In a further embodiment, a radiant barrier layer 50 may be applied to the underside of the panel. Radiant barrier sheathing, typically used for roof and attic sheathing, has become a de facto standard in high solar radiation environments. Radiant barriers are installed in homes and structures, usually in attics, primarily to reduce summer heat gain and reduce cooling costs. The barriers consist of a highly reflective material that reflects radiant heat rather than absorbing it. Radiant heat travels in a straight line away from any surface and heats anything solid that absorbs its energy. Most common insulation materials address conductive and convective heat flow, not radiant heat flow. In contrast, a radiant barrier reduces the radiant heat transfer from the underside of the heated roofing materials to other surfaces in the attic, thereby reducing the cooling load of the house.

A layer of aluminum (typically aluminum foil) is commonly used as the reflective material, as it is efficient at not transmitting radiant energy into the attic environment. The aluminum foil used in radiant barriers must be very pure to achieve a low emittance surface. The thickness of the aluminum does not affect performance; the aluminum only needs to cover the surface of the sheathing material. Typically, very thin foils(approximately 0.00025 inches thick) are used. As this foil is too thin (and thus too fragile) to be applied to wood structural panels directly, it may be attached and bonded to another substrate, most often Kraft paper, for support. The combined overlay is then laminated to one side of a wood structural panel face to make the radiant barrier sheathing. As an alternative to foil, a very thin layer of aluminum (or similar metal) can be deposited via vapor deposition manufacturing processes onto a polyethylene sheet (PET) to form a metallized PET sheet. Like foil, the metallized PET sheet can be laminated to Kraft paper, and the combined overlay is laminated to one side of a wood structural panel face to make the radiant barrier sheathing.

Thus, it should be understood that the embodiments and examples described herein have been chosen and described in order to best illustrate the principles of the invention and its practical applications to thereby enable one of ordinary skill in the art to best utilize the invention in various embodiments and with various modifications as are suited for particular uses contemplated. Even though specific embodiments of this invention have been described, they are not to be taken as exhaustive. There are several variations that will be apparent to those skilled in the art.

What is claimed is:

1. An integrated roofing product, comprising:
a roofing panel or plank, comprising:
a base layer comprising engineered wood, the base layer comprising an outer face, a top edge, a bottom edge, a left edge, and a right edge; and
a silicone layer covering at least a portion of the outer face of the base layer.

2. The product of claim 1, wherein the silicone layer further covers at least one of the edges.

3. The product of claim 1, wherein the silicone layer covers the entire outer face of the base layer.

4. The product of claim 1, wherein the silicone layer further comprises a texturizing material.

5. The product of claim 4, wherein the texturizing material is integrated with the silicone layer.

6. The product of claim 1, wherein the silicone layer covers the top edge and the bottom edge.

7. The product of claim 1, wherein the silicone layer covers the right edge and left edge.

8. The product of claim 1, wherein the upper edge comprises an underlap portion of a shiplap joint.

9. The product of claim 1, wherein the bottom edge comprises an overlap portion of a shiplap joint.

10. The product of claim 8, wherein the underlap portion comprises an underlap joint face parallel to the outer face, and the underlap joint face is covered at least in part by silicone.

11. The product of claim 9, wherein the overlap portion comprises an overlap joint face parallel to the outer face, and the overlap joint face is covered at least in part by silicone.

12. The product of claim 4, wherein the texturizing material comprises ceramic coated granules, rock, glass, or slate.

13. The product of claim 4, wherein the texturizing material comprises rubber, plastic, or a synthetic polymer.

14. The product of claim 1, further comprising a radiant barrier layer.

15. The product of claim 1, wherein the outer surface of the silicon layer is embossed with a pattern.

16. The product of claim 15, wherein the embossed pattern does not provide additional traction or increase the coefficient of friction of the outer surface.

17. A method of producing the integrated roofing product of claim 1, comprising the steps of:
providing a base layer with an outer face, a top edge, a bottom edge, a right edge, and a left edge, said base layer comprising engineered wood;
applying, in a processing line at a manufacturing facility, silicone to at least a portion of the outer face of the base layer.

18. The method of claim 17, further comprising the steps of:
cutting or routing an underlap half of a shiplap joint along the top edge; and
cutting or routing an overlap half of a shiplap joint along the bottom edge.

19. The method of claim 18, further comprising the step of:
applying, in a processing line at a manufacturing facility, silicone to at least a portion of one face of the underlap half, and to at least a portion of one face of the overlap half.

20. The method of claim 17, further comprising the steps of:
embossing an outer surface of the silicone opposite the base layer with a pattern by placing the outer surface in contact with a surface of a patterning plaque while the silicone is still semi-fluid and not fully cured; and
removing the patterning plaque from contact with the outer surface of the silicone, thereby leaving the pattern embossed in the outer surface.
